(19) United States
(12) Patent Application Publication
(10) Pub. No.: US 2011/0115408 A1
(43) Pub. Date: May 19, 2011

(54) LONG LIFE POWER SUPPLY

(75) Inventor: Jamie FANNIN, Lockport, NY (US)

(73) Assignee: S3J ELECTRONICS, LLC., Lancaster, NY (US)

(21) Appl. No.: 12/948,399

(22) Filed: Nov. 17, 2010

Related U.S. Application Data
(60) Provisional application No. 61/262,001, filed on Nov. 17, 2009.

(51) Int. Cl. H05B 37/02

(52) U.S. Cl. 315/294

(57) ABSTRACT

An LED driver for at least one light emitting diode including an input for receiving an input voltage, an output comprising at least one light emitting diode, a current limiting loop for regulating an output current supplied to the at least one light emitting diode, a voltage control loop for monitoring a feedback voltage from the at least one light emitting diode, and a junction including a first diode for closing the current limiting loop and a second diode for closing the voltage control loop, wherein the junction enables the voltage control loop to communicate with the current limiting loop such that the feedback voltage is taken into account by the current limiting loop in regulating the out current.

### CROSS-REFERENCE TO RELATED APPLICATIONS

This patent application claims the benefit under 35 U.S.C. §119(e) of U.S. Provisional Patent Application No. 61/262,001, filed Nov. 17, 2009, which application is incorporated herein by reference.

### FIELD OF THE INVENTION

The invention broadly relates to lighting systems, more specifically to light emitting diodes (LEDs), and even more particularly to a long life power supply for driving one or more LEDs.

### BACKGROUND OF THE INVENTION

LEDs are becoming increasingly popular in a wide range of lighting applications due to their long lifespan and high efficiency when compared to traditional lighting systems, such as incandescent bulbs or gas-discharge lamps. The longer lifespan and higher efficiency makes them not only cheaper to maintain, but also results in less impact on the environment in terms of power consumption.

The brightness of traditional LEDs (also known as white light-emitting diodes, or WLEDs) is determined by the current running through the LEDs. In order to avoid flickering or pulsing of the light emitted by these LEDs, it is important to maintain a constant current through the LEDs. The brightness of organic light-emitting diodes (OLEDs), however, is determined by the voltage applied across the OLEDs. As such, power supplies or drivers have been developed which monitor either the voltage or the current, depending on if LEDs or OLEDs are being driven, but not the voltage and the current simultaneously.

Presently, WLEDs are more popular and widely used in lighting applications than OLEDs, and there are accordingly several known devices and methods for controlling current through an array of LEDs. For example, U.S. Pat. Nos. 7,579,786 (Soos) and 7,394,444 (Kim et al.), which patents are hereby incorporated by reference in their respective entireties, disclose drivers for controlling the current supplied to traditional LED arrays. However, these systems do not monitor or control the voltage to the output LED array. As another example, U.S. Pat. No. 7,583,068 (Wang), which application is hereby incorporated by reference in its entirety, discloses a method for driving voltage or current controlled devices. However, Wang does not disclose a device which controls both voltage and current in the same device; the voltage controlled device in Wang is specifically arranged for use with OLEDs, while the current controlled device is specifically arranged for use with WLEDs.

As a result, different drivers are required to drive different types of LEDs (e.g., WLEDs as opposed to OLEDs). Furthermore, for example, if a traditional LED array is used in which current controls brightness, and one of the LEDs burns or blows out, then the voltage applied to the remaining LEDs in the array would become unnecessarily high, since there would be no voltage drop over the burned out LED. The system would appear to be working correctly because the increased voltage would not affect the brightness of the LEDs (which is instead determined by the controlled current). However, despite the seemingly proper functioning of the LEDs, this unnecessary increase in voltage would likely lead to premature burn out of the remaining LEDs, thereby shortening the lifespan of the LED array.

Accordingly, only one of the only voltage or the current is currently controlled or regulated in a single system. What is needed is a power supply or LED driver that provides two levels of protection by monitoring and regulating both the voltage and the current. Heretofore, there is not an LED driver which will monitor and automatically regulate both the voltage and the current.

Furthermore, electrolytic capacitors (e-caps) are often favored in LED power supply applications because they can have very large capacitances. However, the lifespan of e-caps is often limited, unless under ideal conditions. Due to the generally longer lifespan of the LEDs, the e-caps often become the limiting factor in the lifespan of an LED lighting assembly which includes a power supply that uses e-caps.

The life of e-caps is generally determined by the operating temperature of the e-caps, and the ripple current, particularly at high frequencies, through the e-caps. By keeping both of these values to a minimum, the life of the e-caps can be extended. However, for outdoor lighting assemblies, such as industrial, urban, or street lighting, the temperature can not be easily regulated, because outdoor lighting assemblies typically include a watertight housing that contains the power supply and LEDs, which housing prevents the ventilation required for cooling.

Due to these physical constraints, using a power supply that maintains a low ripple current through the e-caps is important for extending the life of the e-caps. Specifically, the e-caps should last long enough to allow 30-50% light depreciation of the LEDs, since this is when the LEDs are usually replaced under standard practice. Under normal conditions, 30-50% light depreciation happens between 50,000 and 100,000 hours. Some current power supplies are rated for 100,000 hours, but only at 50° C., which temperature is nearly impossible to achieve under actual working conditions. These same power supplies are only rated for approximately 40,000 hours at 80° C., which represents a more reasonable baseline. At 40,000 hours, these prior art power supplies will fail well before the LEDs reach the desired 30-50% light depreciation. Typically, when the e-caps fail, then the entire system will soon also fail because suitable noise filtration is no longer possible.

### SUMMARY OF THE INVENTION

The current invention broadly comprises an LED driver for at least one light emitting diode including an input for receiving an input voltage, an output comprising at least one light emitting diode, a current limiting loop for regulating an output current supplied to the at least one light emitting diode, a voltage control loop for monitoring a feedback voltage from the at least one light emitting diode, and a junction including a first diode for closing the current limiting loop and a second diode for closing the voltage control loop, wherein the junction enables the voltage control loop to communicate with the current limiting loop such that the feedback voltage is taken into account by the current limiting loop in regulating the out current.

In one embodiment, the LED driver further comprises a timing unit for controlling an operating frequency of the LED driver. In another embodiment, the timing unit is isolated from both the voltage control loop and the current limiting loop via at least one transformer. In one embodiment, the LED driver further comprises an optocoupler connected to the voltage control loop, the junction, and the timing unit, wherein the optocoupler is operatively arranged to send a signal from the voltage control loop to the timing unit if the voltage control loop determines that an unnecessarily high voltage is being applied to the at least one light emitting diode. In one embodiment, the at least one light emitting diodes comprises a plurality of light emitting diodes, and the unnecessarily high voltage is a result of one or more light emitting diodes in the plurality burning out or shorting out. In another embodiment, a buffering capacitor is coupled across both sides of the at least one transformer for filtering noise, and wherein at least one filtering loop is included on an output side of the transformer, the filtering loop including a resistor and a capacitor applied across a pair of diodes.

The current invention also broadly comprises a method for driving at least one light emitting diode including (a) monitoring a feedback voltage from the at least one light emitting diode with a voltage control loop of an LED driver, (b) determining an unbalancing or an unnecessarily high output voltage in the LED driver with the voltage control loop by comparing the feedback voltage to a predetermined maximum, (c) communicating the unbalancing to a current limiting loop of the LED driver from the voltage control loop, and (d) regulating an output current of the LED driver with the current limiting loop, taking into account the unbalancing communicated by the voltage control loop in step (b). In one embodiment, the method further comprises (e) modifying an operating frequency of the LED driver based on the unnecessarily high output voltage determined in step (b).

### BRIEF DESCRIPTION OF THE DRAWINGS

The nature and mode of operation of the present invention will now be more fully described in the following detailed description of the invention taken with the accompanying drawing figures, in which:

FIG. 1 is a simplified schematic of a circuit according to the current invention; and,

FIG. 2 is an exemplary schematic of a circuit according to the current invention.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the terms “power supply”, “circuit”, “driver”, etc., may be used interchangeably to generally refer, either physically or schematically, to the electrical components that power, drive, monitor, and control the LEDs. Furthermore, the term LED will be used throughout, although different types of LEDs, such as high power LEDs (HPLED), or even other lighting components requiring a similar power supply may be driven according to the current invention. “Circuit”, “loop”, or “unit” may be used herein to refer generally to any arrangement of related electronic components and/or wiring. Although any methods, devices or materials similar or equivalent to those described herein can be used in the practice or testing of the invention, the preferred methods, devices, and materials are now described.

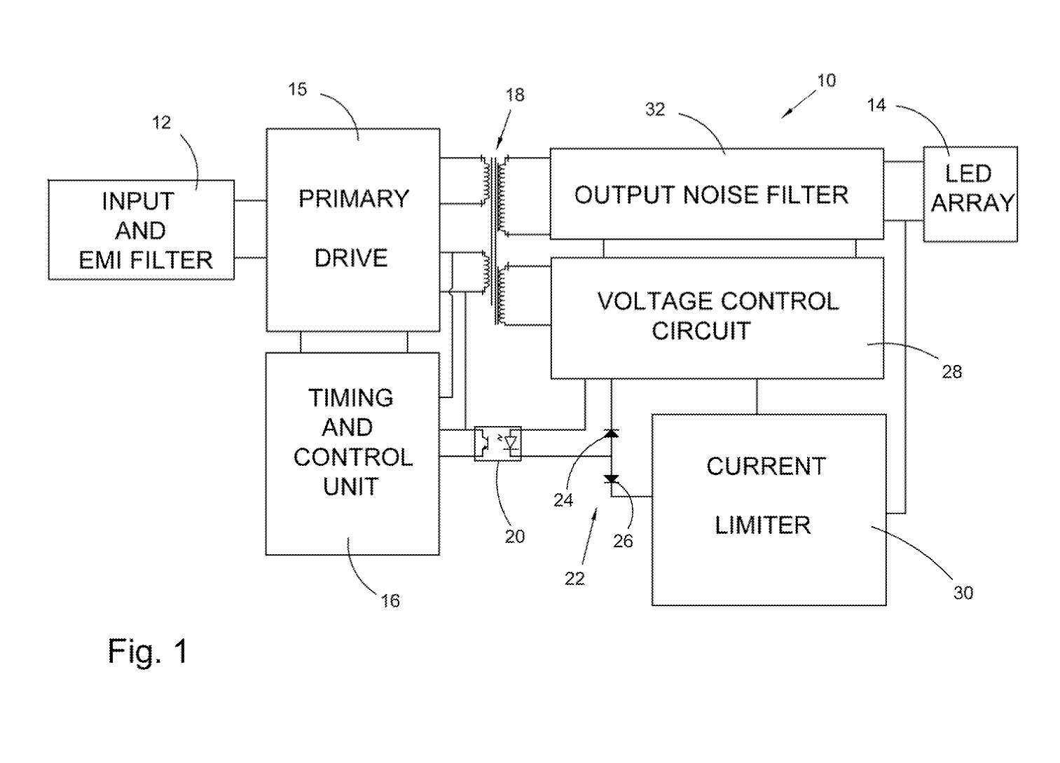

Referring now to the figures, FIG. 1 shows a simplified schematic of an LED driver according to the current invention. LED driver 10 includes input 12 and output 14 on opposite sides of the circuit. The input could be arranged to receive alternating or direct current. The input may also include an electromagnetic interference (EMI) filter for reducing any disturbance caused any electromagnetic or radio frequency interference.

Primary drive 15 is connected to the input 12 and controlled by timing and control unit 16. The timing and control unit uses, for example, pulse width modulation (PWM) to control the output of primary drive 15 to transformer 18. The timing and control unit is also arranged to receive signals via optocoupler 20. Optocouplers are also known as opto-isolators, photocouplers, or optical isolators, and their general use is known in the art for transmitting electrical signals in the form of light between two otherwise electrically isolated circuits. Thus, the input, primary drive, and timing and control unit are isolated from the output side of driver 10 via transformer 18 and optocoupler 20. The optocoupler is also connected on the output side of driver 10 to junction 22, which includes diode 24 and diode 26. Diode 24 is included to close voltage control loop or circuit 28, while diode 26 is included to close current limiting loop 30. Voltage control loop 28 and current limiting loop 30 may simply be referred to as the voltage loop and current loop, respectively. Output noise filter 32 is included, including, for example, a plurality of e-caps, as described in more detail below to filter ripple current noise and the like from the system.

Generally, voltage control loop 28 is included to monitor the feedback voltage from LED array 14 in case the feedback voltage rises over a predetermined maximum. If the feedback voltage from the LEDs increases over a predetermined maximum, the voltage control loop will communicate this unbalancing to current limiting loop 30. Current limiting loop 30 regulates the output current to the LED array. As described above, it is important for the current running through to the LEDs to remain constant because the current determines the brightness of the LEDs. The current limiting loop may, for example, regulate the current by comparing a measured voltage with a reference voltage, taking into account the feedback voltage monitored by the voltage loop, and altering the output voltage to LED array 14 so that the measured voltage remains within a certain predetermined acceptable range of the reference voltage. In this way, constant output current can be maintained through the LED array.

Voltage control loop is also included in the event that one or more LEDs in LED array 14 shorts or burns out. The reference voltage is determined based on a full array of functioning LEDs. If one LED burns out, then there will be no voltage drop over that LED, and the measured output voltage will be unnecessarily high. If the output voltage to the remaining LEDs becomes unnecessarily high, the likely result is that the remaining LEDs suffer premature burn out. Since prior art systems are only concerned with maintaining a constant output current, these prior art drivers would continue maintaining the constant predetermined current based on the same reference voltage, regardless of the number of LEDs that have burned or shorted out. Based on the determination of unnecessarily high voltage by voltage loop 28, optocoupler 20 will send a corresponding signal to timing circuit 16. The signal from optocoupler 20 will cause the timing circuit to, for example, lower the operating frequency of the circuit, which will drop the input voltage received by input 12.

As one example, if several LEDs in an array, such as array 14, are to burn out, the power required by the system may drop from 36 W to 30 W. The signal from the optocoupler will instruct timing circuit 16 that this drop from 36 W to 30 W is necessary, and the input voltage will drop accordingly due to a change in the operating frequency set by the timing unit. Since the input voltage is dropped, the total power consumed by the system is kept to a minimum, thereby maintaining a potentially longer lifespan for the remaining LEDs and other driver components.

Accordingly, if the voltage to the LEDs raises higher than the required set output voltage, for example by a diode failing in an open mode of operation, circuit 10 will automatically self adjust both the current and voltage to the LED array in order to maintain maximum allowable values for the voltage and current. Additionally, if an LED is shorted in a closed mode of operation, the current to the LEDs will become unnecessarily high, and the circuit will also self adjust the current to the LEDs. It should thus be appreciated that driver 10 offers two levels of protection to the LEDs by utilizing a dual closed loop design that simultaneously monitors both the current and the voltage sent to the LEDs and by permitting communication between the loops such that the current loop can take into account the voltages monitored by the voltage loop. Heretofore, only one parameter, the voltage or the current, but not both, could be monitored and controlled at a time.

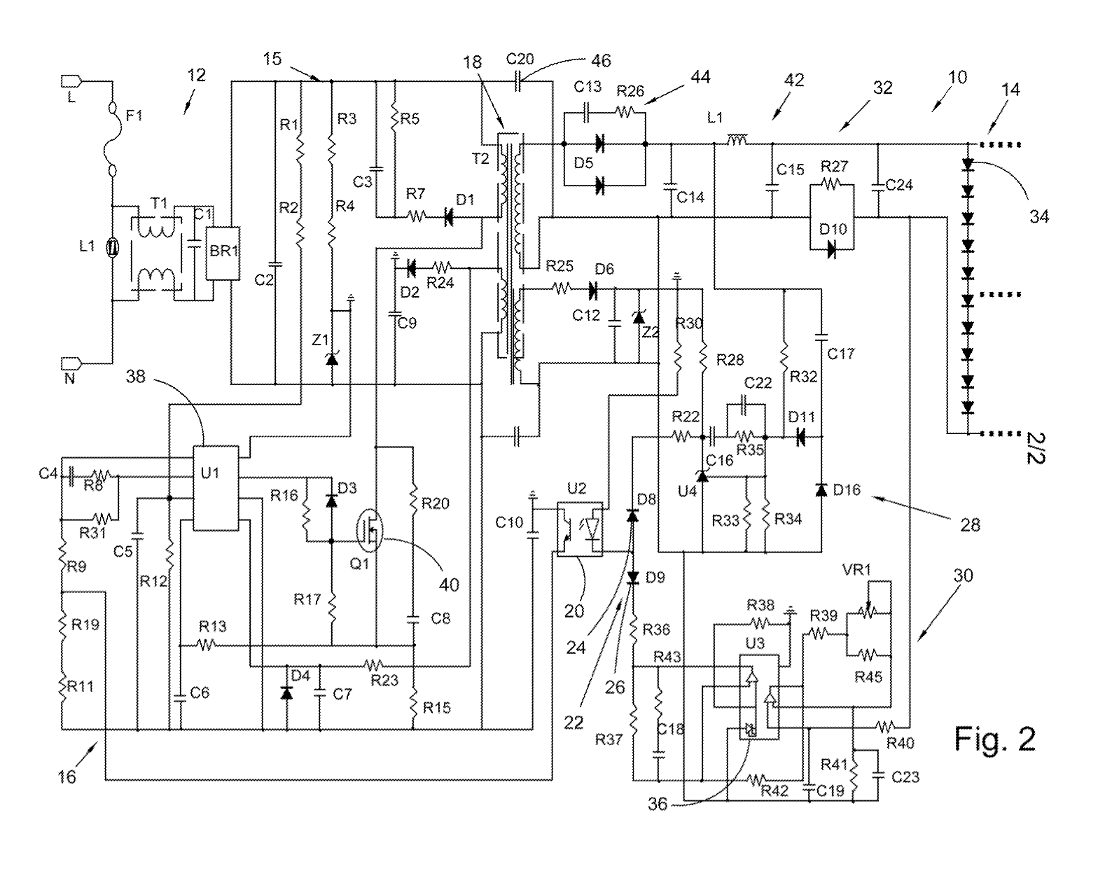

Further advantages can be appreciated in view of the more detailed embodiment of driver 10 shown in FIG. 2. In this embodiment, the basic components shown in FIG. 1 are included, such as input 12, output 14, primary driver 15, timing unit 16, transformer 18, optocoupler 20, junction 22 including diodes 24 and 26, voltage loop 28, and current loop 30. Various other components, such as resistors, capacitors, integrated circuits, inductors, etc. are shown in FIG. 2. These additional components are shown both with standard symbols and labeled with an alphanumeric identifiers. For example, capacitors are indicated by the commonly known symbol ‘∥’ and are labeled C1, C2, C3, etc. In view of these symbols and identifiers, a discussion of each individual component is not necessary, as one of ordinary skill in the art can appreciate the general purpose of each of those components not otherwise specifically discussed herein. It should be appreciated with respect to FIG. 2 that any four way intersection of wires (that is, resembling a ‘+’) indicates a crossing of the wires, not a node, except where indicated by a bold dot (that is, resembling a ‘•’), which dot does indicate a node. Like the dot, any three-way intersection (that is, resembling a ‘T’) indicates a connection or node between the wires.

In the embodiment of FIG. 2, input 12 receives a voltage input from an AC source. Output array 14 is comprised of LEDs 34, which are arranged in banks, columns, or rows. One such bank is shown in FIG. 2, including ten LEDs 34 connected in series. It should be appreciated that any number of LEDs could be included in each bank, and any number of banks could be included connected in parallel in array 14, but that array 14 should include at least one LED. The AC voltage input is transferred to primary drive 15, such as via a bridge rectifier (e.g., bridge rectifier BR1, which may have part number KBP210G or any other suitable component), which is further transferred via transformer 18 to the output, thereby isolating the input from the output. Timing circuit 16 operates, for example, by pulse width modulation (PWM), and may include a transition mode PFC controller 38 (also generally labeled U1, which may have part number L6562) and power MOSFET 40 (also generally labeled Q1, which may have part number 7N80) in order to control an operating frequency of the circuit. It has been found that selecting components with low switching noise, such as by those part numbers indicated, increases desired performance. It should of course be appreciated that other components could be used as necessary for individual applications and that the schematic of FIG. 2 is provided as one example only.

Timing unit 16 is in communication with voltage circuit 28 via optocoupler 20, such that the optocoupler can send signals to the timing unit when the voltage loop detects improperly high feedback voltages, as described above. Diodes 24 and 26 (also generally labeled D8 and D9, respectively, which both may have part number LL4148) are included at junction 22 to close the voltage loop and current loop, respectively. However, as described above, the voltage loop and current loop are kept in communication such that the current loop can take into account the feedback voltage levels that are monitored by the voltage loop in order to more effectively regulate the output current. For example, current loop 30 includes a dual operational amplifier, which may be included in voltage reference monolithic integrated circuit 36 (also generally labeled U3, which may have part number TSM103W). Integrated circuit 36 regulates the current by comparing a measured voltage with a reference voltage, and altering the output voltage to LED array 14 such that the measured voltage remains within a certain predetermined acceptable range of the reference voltage in order to maintain a constant output current through the LED array. Since a constant current is required to maintain proper functioning of typical LEDs, integrated circuit 36 will likely be constantly making adjustments to the output voltage to maintain a constant current through the LEDs during operation of driver 10.

In addition to self-regulating the output voltage and current to the LEDs, circuit 10 is designed to also enable longer life of the e-caps, specifically, the output filtering capacitors in noise filter 32 (see, for example, the capacitors labeled C14 and C24). Noise is created by the components of circuit 10, such as timing circuit 16 and integrated circuit 36, as these components switch on and off. For this reason, parts should be selected which have low noise characteristics, such as those part numbers identified above, but it should be understood that other parts could be substituted for these specific part models, especially other models which result in low ripple current noise. Particularly during startup, there is an in rush or spike of high frequency current to the LEDs, which should be filtered for better performance. The filtering capacitors are included for this purpose, but it is still important to keep the ripple current through the capacitors to a minimum to ensure a longer life.

Furthermore, LC loop 42 may be included having an inductor (for example, the inductor labeled L1) and a capacitor (for example, the capacitor labeled C15) to provide enhanced filtering of noise before the current is output to the LEDs. In addition, buffering unit 46 may be provided between opposite sides of transformer 18, such as by use of capacitor (for example, the capacitor generally labeled C20). Buffering unit 46 is provided in conjunction with RC loop 44, which includes a resistor (for example, the resistor generally labeled R26) and a capacitor (for example, the capacitor generally labeled C13) applied across a pair of diodes (for example, the diodes generally labeled D5). A large capacitance is desired for buffering unit 46, however, large capacitances significantly slow down the speed of the circuit. Advantageously, including RC loop 44 enables a much smaller capacitance to be used for buffering unit 46, so that spikes and noise will be filtered primarily through the RC loop, thereby preventing overly reducing the speed of the circuit.

It should again be appreciated that the above specific embodiment should not be considered to limit the scope of the current invention, but instead only to exemplify one particular embodiment of a circuit for a power supply which can be used to drive an array of LEDs. The power supply disclosed in FIG. 2 is intended to be variable between 5 W and 140 W, as needed to power arrays of LEDs of different sizes and configurations. The shown circuit may have an operating frequency of 120 Hz, a power factor of about 95.95, and regulate an output voltage to the LEDs to 0.7V peak to peak. Drivers according to the current invention and as exemplified in FIG. 2 are capable of maintaining a lifespan of at least approximately 75,000 hours (before failure or unacceptable brightness degradation) at 80° C. due to the unique selection and arrangement of parts to reduce noise to the e-caps, and self-regulation of both the output and voltage and current, versus prior art power supplies which are only rated for only about 40,000 hours at this temperature. One of ordinary skill in the art will readily appreciate that there are numerous ways to arrange components in an electronic circuit, and that the benefits of a dual closed loop voltage and current regulating arrangement and low noise maintenance techniques could be utilized by any number of circuit designs. As such, more or less resistors, capacitors, diodes, and other components, or the same number of these components having different values, could be included, as desired, for each individual application of the current invention principles.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. An LED driver for at least one light emitting diode comprising:
an input for receiving an input voltage;
an output comprising at least one light emitting diode;
a current limiting loop for regulating an output current supplied to said at least one light emitting diode;
a voltage control loop for monitoring a feedback voltage from said at least one light emitting diode; and,
a junction including a first diode for closing said current limiting loop and a second diode for closing said voltage control loop, wherein said junction enables said voltage control loop to communicate with said current limiting loop such that the feedback voltage is taken into account by said current limiting loop in regulating said output current.

2. The LED driver recited in claim 1 further comprising a timing unit for controlling an operating frequency of said LED driver.

3. The LED driver recited in claim 2, wherein said timing unit is isolated from both said voltage control loop and said current limiting loop via at least one transformer.

4. The LED driver recited in claim 3 further comprising an optocoupler connected to said voltage control loop, said junction, and said timing unit, wherein said optocoupler is operatively arranged to send a signal from said voltage control loop to said timing unit if said voltage control loop determines that an unnecessarily high voltage is being applied to said at least one light emitting diode.

5. The LED driver recited in claim 4, wherein said at least one light emitting diodes comprises a plurality of light emitting diodes, and said unnecessarily high voltage is a result of one or more light emitting diodes in said plurality burning out or shorting out.

6. The LED driver recited in claim 3, wherein a buffering capacitor is coupled across both sides of said at least one transformer for filtering noise, and wherein at least one filtering loop is included on an output side of said transformer, said filtering loop including a resistor and a capacitor applied across a pair of diodes.

7. A method for driving at least one light emitting diode comprising:
(a) monitoring a feedback voltage from said at least one light emitting diode with a voltage control loop of an LED driver;
(b) determining an unbalancing or an unnecessarily high output voltage in said LED driver with said voltage control loop by comparing said feedback voltage to a predetermined maximum;
(c) communicating said unbalancing to a current limiting loop of said LED driver from said voltage control loop; and,
(d) regulating an output current of said LED driver with said current limiting loop, taking into account said unbalancing communicated by said voltage control loop in step (b).

8. The method recited in claim 7 further comprising:
(e) modifying an operating frequency of said LED driver based on said unnecessarily high output voltage determined in step (b) for reducing said unnecessarily high voltage.
